(19) United States
(12) Patent Application Publication
(10) Pub. No.: US 2012/0074686 A1
(43) Pub. Date: Mar. 29, 2012

(54) CONNECTOR FOR AN OIL DRAIN VALVE

(76) Inventor: George CHANG, Taipei (TW)

(21) Appl. No.: 12/893,548

(22) Filed: Sep. 29, 2010

(51) Int. Cl. F16L 55/00

(52) U.S. Cl. 285/80

(57) ABSTRACT

A connector for an oil drain valve has a body and a locking arm. The body has a sleeve and two pivotal ears separately formed on and protrude from the outer surface of the sleeve. Each pivotal ear has a pivotal hole and a locking hole. The locking arm is pivotally mounted between the pivotal ears and has a cam segment and a locking hole. The cam segment is formed on one end of the locking arm and is eccentric to a pivoting hole in the locking arm. The locking hole is formed through the locking arm and selectively aligns with the locking holes in the pivotal ears of the body. Accordingly, the connector can provide an excellent sealing effect and keep the connector disengaging unintentionally from the oil drain valve during the oil-draining process.

### BACKGROUND OF THE INVENTION

1. Field of the Invention

The present invention relates to a connector, and more particularly to a connector for an oil drain valve to provide an excellent sealing effect and to keep the connector disengaging unintentionally from the oil drain valve during the oil-draining process.

2. Description of Related Art

To drain oil from a tank truck to an underground oil depot, an oil pipe is used and has two ends connected respectively with a drain connector and a depot connector. The drain connector is connected to an oil drain valve on the tank trunk to allow oil in the tank truck being input into the oil depot via the connectors and the oil pipe. To prevent oil leakage and a fire from occurring, an excellent sealing conjunction between the connector and the valve is an important issue. Additionally, a conventional connector does not have a locking mechanism to keep the connector from disengaging from the valve unintentionally, so the conventional connector may be detached from the valve due to an external force or carelessness of an operator.

To overcome the shortcomings, the present invention tends to provide a connector for an oil drain valve to mitigate or obviate the aforementioned problems.

### SUMMARY OF THE INVENTION

The main objective of the invention is to provide a connector for an oil drain valve to provide an excellent sealing effect and to keep the connector disengaging unintentionally from the oil drain valve during the oil-draining process.

The connector has a body and a locking arm. The body has a sleeve, a connection tube, a sealing ring, two pivotal ears and a notch. The sleeve is adapted to connect to the oil drain valve and has an outer surface and an end. The connection tube protrudes obliquely from the end of the sleeve. The sealing ring is mounted in the sleeve. The pivotal ears are separately formed on and protrude from the outer surface of the sleeve. Each pivotal ear has a pivotal hole and a locking hole. The pivoting hole aligns with the pivoting hole in the other pivotal ear. The locking hole aligns with the locking hole in the other pivotal ear. The notch is defined through the outer surface of the sleeve at a position between the pivotal ears. The locking arm is pivotally mounted between the pivotal ears and has a pivotal end, a pivoting hole, a pivotal pin, a cam segment and a locking hole. The pivoting hole is formed through the pivotal end of the locking arm and aligns with the pivoting holes in the pivotal ears on the body. The pivotal pin is mounted through the pivoting holes in the pivotal ears and the locking arm to pivotally connect the locking arm to the pivotal ears. The cam segment is formed on the pivotal end of the locking arm and is eccentric to the pivoting hole in the pivotal end. The locking hole is formed through the locking arm and selectively aligns with the locking holes in the pivotal ears of the body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a connector for an oil drain valve in accordance with the present invention combined with a joint of the oil drain valve;

FIG. 2 is an exploded perspective view of the connector with the joint of the oil drain valve in FIG. 1;

FIG. 3 is a cross sectional side view of the connector with the joint of the oil drain valve in FIG. 1 in an uncombined condition;

FIG. 4 is a cross sectional side view of the connector with the joint of the oil drain valve in FIG. 1 in a combined condition;

FIG. 5 is a perspective view of the connector in FIG. 1 in a locked condition;

FIG. 6 is a perspective view of another embodiment of a connector in accordance with the present invention in a locked condition; and

FIG. 7 is a cross sectional side view of the connector with the joint of the oil drain valve in FIG. 6 in an uncombined condition.

### DETAILED DESCRIPTION OF PREFERRED EMBODIMENT

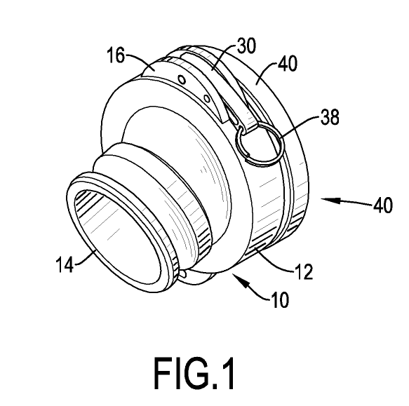

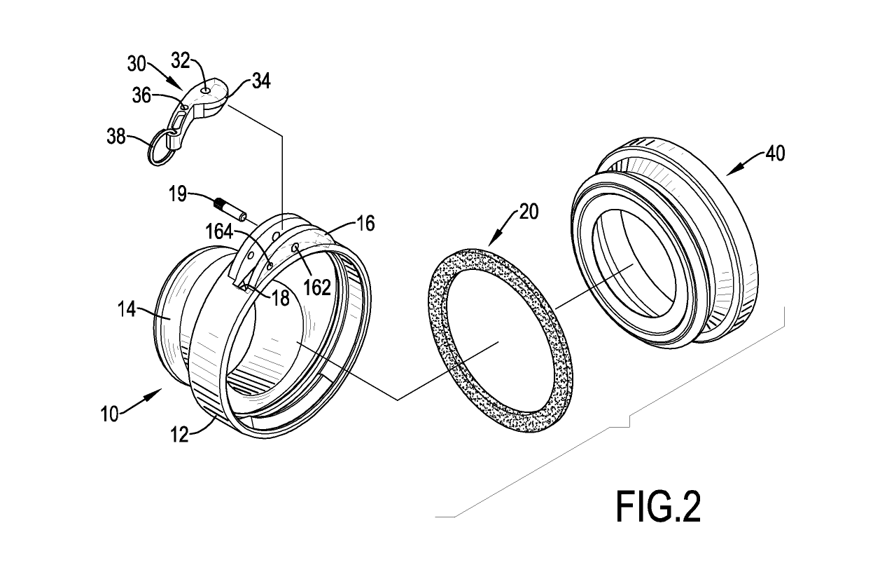

With reference to FIGS. 1 to 3, a connector for an oil drain valve in accordance with the present invention comprises a body 10 and a locking arm 30. The body 10 has a sleeve 12, a connection tube 14, a sealing ring 20, two pivotal ears 16 and a notch 18. The sleeve 12 is formed on one end of the body 10, is connected to a joint 40 of the oil drain valve and has an outer surface and an end. Preferably, the outer surface of the sleeve 12 is round. The connection tube 14 is formed on the other end of the body 10 and protrudes obliquely from the end of the sleeve 12. Preferably, the connection tube 14 is integrally formed on the sleeve 12 as a single piece. The sealing ring 20 is mounted in the sleeve 12. The pivotal ears 16 are separately formed on and protrude from the outer surface of the sleeve 12, and each pivotal ear 16 has a pivoting hole 162 and a locking hole 164. The pivoting hole 162 is defined through the pivotal ear 16 and aligns with the pivoting hole 162 in the other pivotal ear 16. The locking hole 164 is defined through the pivotal ear 16, aligns with the locking hole 164 in the other pivotal ear 16 and is away from the pivoting hole 162 in the pivotal ear 16. The notch 18 is defined through the outer surface of the sleeve 12 at a position between the pivotal ears 16 and communicates with the inner space of the sleeve 12.

The locking arm 30 is pivotally mounted between the pivotal ears 16 of the body 10, may be curved corresponding to the round outer surface of the sleeve 12 and has a pivotal end, a pivoting hole 32, a pivotal pin 19, a cam segment 34, a locking hole 36 and a pulling ring 38. The pivoting hole 32 is formed through the pivotal end of the locking arm 30 and aligns with the pivoting holes 162 in the pivotal ears 16 on the body 10. The pivotal pin 19 is mounted through the pivoting holes 162,32 in the pivotal ears 16 and the locking arm 30 to pivotally connect the locking arm 30 to the pivotal ears 16. The cam segment 34 is formed on the pivotal end of the locking arm 30, is eccentric to the pivoting hole 32 in the pivotal end and selectively protrudes into the sleeve 12 via the notch 18. The cam segment 34 of the locking arm 30 has a side face facing to the connection tube 14, and the side face has two ends and a thickness gradually increasing from one end to the other end of the side face. The locking hole 36 is formed through the locking arm 30 and selectively aligns with the locking holes 164 in the pivotal ears 16 of the body 10. The pulling ring 38 is mounted on the locking arm 30 at an end opposite to the pivotal end of the locking arm 30. With the arrangement of the pulling ring 38, a user can pivot the locking arm 30 relative to the pivotal ears 16 of the body 10 easily.

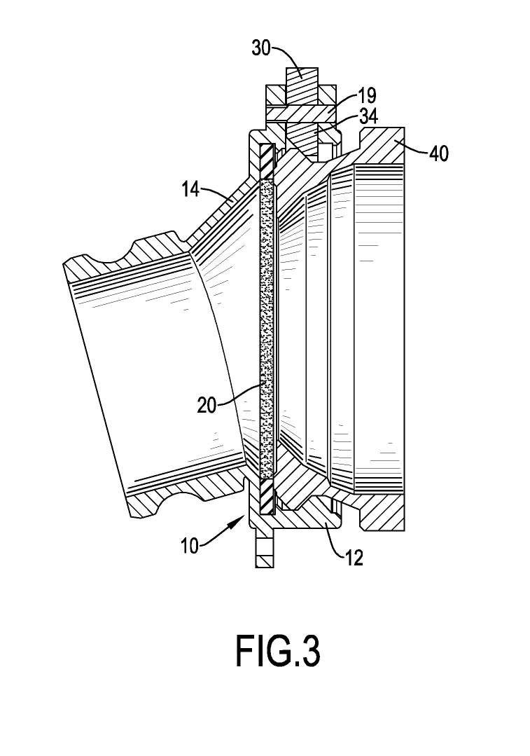

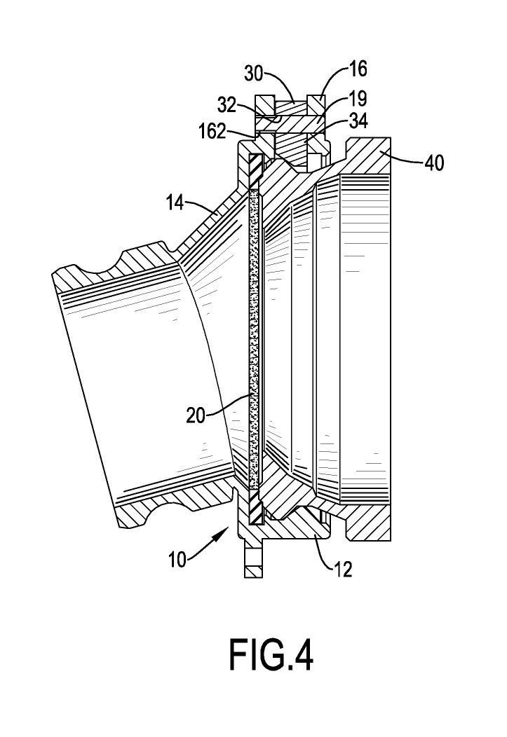

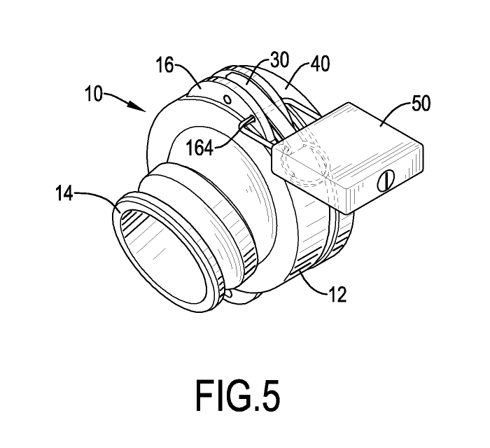

With reference to FIGS. 3 to 5, to connect the connector with an oil drain valve, the sleeve 12 is mounted around a joint 40 of the oil drain valve. The locking arm 30 is then pivoted relative to the body 10 to make the cam segment 34 of the locking arm 30 protruding into the sleeve 12 via the notch 18. The cam segment 34 can push the joint 40 to move further into the sleeve 12 and firmly abut against the sealing ring 20 in the sleeve 12 with the pivotal rotation of the locking arm 30. The cam segment 34 can also provide a force to hold the joint 40 of the oil drain valve at a position where abuts firmly with the sealing ring 20. Accordingly, an excellent sealing effect can be provided to the conjunction between the connector and the oil drain valve to prevent oil leakage occurring during the oil-draining process.

At the combined condition of the connector with the joint 40 of the oil drain valve, the locking hole 36 in the locking arm 30 aligns with the locking holes 164 in the pivotal ears 16 on the body 10. Consequently, a locker 50 or a locking pin can be mounted through the aligning locking holes 164,36 in the pivotal ears 16 and the locking arm 30 to make the connector at a locked condition. Accordingly, the connector is kept from disengaged from the joint 40 of the oil drain valve unintentionally even when an external force applied to the connector or the oil drain valve. The safety of using the connector and the oil-draining process can be improved.

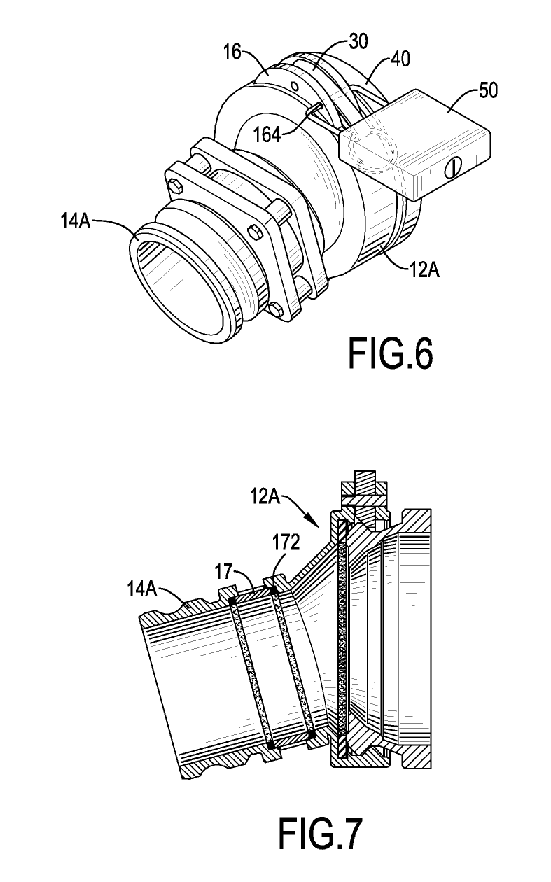

With reference to FIGS. 6 and 7, in another embodiment in accordance with the present invention, the connection tube 14A and the sleeve 12A are separate parts and are connected with each other with fasteners. In addition, a transparent window tube 17 is mounted between the sleeve 12A and the connection tube 14A and has two ends respectively connected to the sleeve 12A and the connection tube 14A. Two O-rings 172 are mounted respectively between the ends of the window tube 17 and the sleeve 12A and the connection tube 14A. With the arrangement of the transparent window tube 17, the oil flow in the connector can be easily observed to keep the connector from being detached from the oil drain valve before the oil-draining process is completed. Oil leakage, industry accident and environment pollution can be prevented.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector for an oil drain valve comprising:
a body having
a sleeve adapted to connect to the oil drain valve and having an outer surface and an end;
a connection tube protruding obliquely from the end of the sleeve;
a sealing ring mounted in the sleeve;
two pivotal ears separately formed on and protruding from the outer surface of the sleeve, and each pivotal ear having
a pivoting hole aligning with the pivoting hole in the other pivotal ear; and
a locking hole aligning with the locking hole in the other pivotal ear; and
a notch defined through the outer surface of the sleeve at a position between the pivotal ears; and
a locking arm pivotally mounted between the pivotal ears and having
a pivotal end;
a pivoting hole formed through the pivotal end of the locking arm and aligning with the pivoting holes in the pivotal ears on the body;
a pivotal pin mounted through the pivoting holes in the pivotal ears and the locking arm to pivotally connect the locking arm to the pivotal ears;
a cam segment formed on the pivotal end of the locking arm and being eccentric to the pivoting hole in the pivotal end; and
a locking hole formed through the locking arm and selectively aligning with the locking holes in the pivotal ears of the body.

2. The connector as claimed in claim 1, wherein the cam segment of the locking arm having a side face facing to the connection tube and having two ends and a thickness gradually increasing from one end to the other end of the side face.

3. The connector as claimed in claim 2, wherein the locking arm further has a pulling ring mounted on the locking arm at an end of the locking arm opposite to the pivotal end of the locking arm.

4. The connector as claimed in claim 3, wherein the outer surface of the sleeve is round; and
the locking arm is curved corresponding to the round outer surface of the sleeve.

5. The connector as claimed in claim 4, wherein the connection tube is integrally formed on the sleeve as a single piece.

6. The connector as claimed in claim 4, wherein the connection tube and the sleeve are separate parts and are connected with each other with fasteners; and
the body further has
a transparent window tube mounted between the sleeve and the connection tube and having two ends respectively connected to the sleeve and the connection tube; and
two O-rings mounted respectively between the ends of the window tube and the sleeve and the connection tube.

7. The connector as claimed in claim 1, wherein the locking arm further has a pulling ring mounted on the locking arm at an end of the locking arm opposite to the pivotal end of the locking arm.

8. The connector as claimed in claim 1, wherein the outer surface of the sleeve is round; and
the locking arm is curved corresponding to the round outer surface of the sleeve.

9. The connector as claimed in claim 1, wherein the connection tube is integrally formed on the sleeve as a single piece.

10. The connector as claimed in claim 1, wherein the connection tube and the sleeve are separate parts and are connected with each other with fasteners; and
the body further has
a transparent window tube mounted between the sleeve and the connection tube and having two ends respectively connected to the sleeve and the connection tube; and
two O-rings mounted respectively between the ends of the window tube and the sleeve and the connection tube.
